(19) United States
(12) Patent Application Publication
(10) Pub. No.: US 2022/0127042 A1
(43) Pub. Date: Apr. 28, 2022

(54) Means to hold together multiple containers and securely fasten interchangeable decorative coverings

(71) Applicant: Cynthia Hansen, Galveston, TX (US)

(72) Inventor: Cynthia Hansen, Galveston, TX (US)

(21) Appl. No.: 17/146,022

(22) Filed: Jan. 11, 2021

Related U.S. Application Data
(60) Provisional application No. 63/105,151, filed on Oct. 23, 2020.

(51) Int. Cl. B65D 25/02; F16B 37/16; F16B 35/00

(52) U.S. Cl. CPC B65D 25/02; F16B 37/16; B65D 2203/00; B65D 2313/00; F16B 35/00

(57) ABSTRACT

In its preferred embodiment, my invention presents a product and method whereby a series of containers can be held together along a longitudinal axis, a decorative covering can be held securely to a container, and an individual can easily and quickly change the appearance of the container by removing the attached covering and securely attaching another without need of an additional securing means included in either of the coverings. Changing the covering can be for reasons such as matching the look to a specific color scheme or to the surroundings it is in, to coordinate colors/theme of a specific holiday, or to align with a child's interests, such as a favorite sport they are involved in or a field of interest they follow.

### CROSS REFERENCE TO RELATED APPLICATIONS

This application claims the earlier filing date of Provisional Patent Filing No. 63/10515 EFS ID #40937064 received 23 Oct. 2020.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention presents an improvement to means for holding multiple containers together, to more securely attaching a decorative covering to a container, to the ease of changing the decorative coverings and improvements in the appearance of decorative coverings when attached on the outer surface of a container.

In its preferred embodiment, my invention presents a product and method whereby a series of containers can be held together along a longitudinal axis, a decorative covering can be held securely to a container, and an individual can easily and quickly change the appearance of the container by removing the attached covering and securely attaching another covering without need of an additional securing means included in either of the coverings. Changing the covering can be for reasons such as matching the look to a specific color scheme or to the surroundings it is in, to coordinate colors/theme of a specific holiday, or to align with a child's interests, such as a favorite sport they are involved in or a field of interest they follow.

Speaking generally, there are benefits to items that serve a multitude of purposes, rather than being singularly dedicated to one use or application and therefor requiring a complete additional item in order to perform a slightly different but related function. For example, when one has something that serves many needs, there is a reduction in the storage space needed for multiple items, the cost is reduced when an entire item does not need to be re-purchased, and a multitude of visual surroundings or events can be quickly coordinated at little effort or cost.

The challenge is to incorporate design features into the base article such that only minor changes are required in order to expand that item's functionality or appearance in order to satisfy many different but related needs and situations.

To date, there have been a variety of devices presented that are used to hold together 2 or more containers along a longitudinal axis, as well as separate methods to attach a decorative covering to a container, some offering a permanent attachment of decorative coverings, and others that are removable.

Prior art does not disclose a device or means to secure multiple containers together along a longitudinal axis while at the same time securing a decorative cover over the container(s).

Issues that come with prior art include a non-secure and non-reliable and/or complicated method of attachment used to connect the containers, a non-secure method to attach the covering to a container, a disorderly or haphazard look to the assembled article, limitations in the variety of colors or patterns for the covering, variances in how well the fit is on different size containers, inconsistent appearances when applied to different sizes of containers and the need for the covering to include the means of attachment in its design, thereby increasing the cost of coverings and decreasing the selection of coverings that can be used as they need to also incorporate the attachment means in its structure.

This has created a need for a product and method that allows—
secure attachment of 2 or more containers along a longitudinal axis,
supports secure attachment of decorative coverings to a container,
simplifys the design requirements for coverings,
provides improvements to the ease of changing the decorative coverings,
results in improvements to the appearance of decorative coverings when attached on the outer surface of a container.

None of the prior art discloses a design that supports the secure attachment of 2 or more containers along a longitudinal axis, secure attachment of decorative coverings onto a container and provision of easily changing the decorative coverings of a container.

For example,

Roberts—patent application # 2006/0179713 Planter Cover claims a planter cover that is held onto a planter (i.e. clay pot) by means included in the cover itself (e.g. elastic, hook and loop) or incorporation of separate fastener(s) that have the sole purpose of holding the covering to the planter. There is no inclusion of any means to hold together additional planters nor of any means to attach a different cover without that additional cover also including the attachment means as part of its integral structure.

Marks—U.S. Pat. No. 9,241,585 Waterproof Plant Pot Holder claims an adjustable plant pot holder or covering that, by means of elastic and stretchable elements incorporated into the fabric, creates a decorative element for plants. No mention is made of any means to hold together additional pots nor of the ability to make use of any different decorative coverings without them also including the same stretchable elements in the actual covering itself.

Herzog-Mesrobian and Seibel—U.S. Pat. No. 6,108,974 Cover Sleeve for Pot claims another design incorporating elastic means of fastening a decorative cover to a planter, but makes no means of attaching and supporting multiple pots together nor fastening a different cover without that cover including the same elastic attachment means in the cover itself.

### BRIEF SUMMARY OF THE INVENTION

This invention presents an improvement to how multiple containers are held together securely along a longitudinal axis, improvements to how a decorative covering is attached securely to a container, improvements to the ease of changing the decorative coverings, simplifications to the design requirements for additional coverings and improvements in the appearance of decorative coverings when attached on the outer surface of a container.

A primary component of my design includes the means by which 2 or more containers are held in juxtaposition to each other yet can be easily separated, and the means of securing (yet easily changing) a decorative element as a result of the specifics of my design.

Specifically, in its preferred embodiment, my invention presents a product and method that provides secure attachment of 2 or more containers, as well as secure attachment of a decorative covering applied to one or more of the containers, provides improvements to the ease of changing the decorative coverings and results in improvements to the appearance of decorative coverings when attached on the outer surface of a container.

In one of my invention's preferred embodiments, a container has an open bottom end and a partially closed top end with a hole in the center. Another similar container is located on top of the first container, but with an open top end and a completely closed bottom end. In this particular embodiment the lower container can be a clay pot used for plants, placed upside down, and the upper container can be a glass jar placed right side up on top of the lower container and used to hold small pieces of candy.

In operation, the lower container is covered with a decorative element, such as cloth material, that must be held securely to the clay pot but allow easy removal and replacement. The decorative element can be of a design and color consistent with a holiday, season or event, such as Christmas, Valentine's Day, autumn, or a child's birthday or specific field of interest.

A means of attaching a threaded connector is fastened to the underside of the upper container, with this threaded connector extending downward through the lower container, and finally through a rigid planar surface perpendicular to the axis of the threaded connector. The rigid planar surface is of a shape and size as to be pulled upward against the inner surface of the lower container when a fastener (ie nut or wingnut) is threaded onto the threaded connector.

The decorative covering is of a size such that its lower edge is long enough to wrap over the lower edge of the open end of the lower container, and its upper edge can be folded over the top edge of the upper container. The folded over upper edge of material becomes trapped between the upper end of the lower container and the lower end of the upper container, while the lower edge of the covering becomes trapped between the inner surface of the lower container and the outer edge of the planar surface as the planar surface moves upward by the attaching wingnut threading onto the threaded connector running axially through the assembly. This places a tensioning force on the covering which gives a smooth and unwrinkled look to the outer surface of the covering, while capturing both ends of the covering.

The object of the present invention is to enable an individual to easily and securely fasten 2 or more containers together along a longitudinal axis while at the same time securely holding a decorative covering onto one or more of the containers.

A further object of the invention is to provide a means whereby an individual can easily and conveniently change the covering at will.

A further object of the invention is to increase the range of potential coverings because there is no need to include any means of attachment incorporated into the covering because of the function of my invention.

A further object of the invention is to provide a single assembly that can inexpensively, easily and quickly be changed in appearance without replacing the entire item.

### BRIEF DESCRIPTION OF THE DRAWINGS

FIG. 1 shows an example of one of the preferred embodiments of the invention.

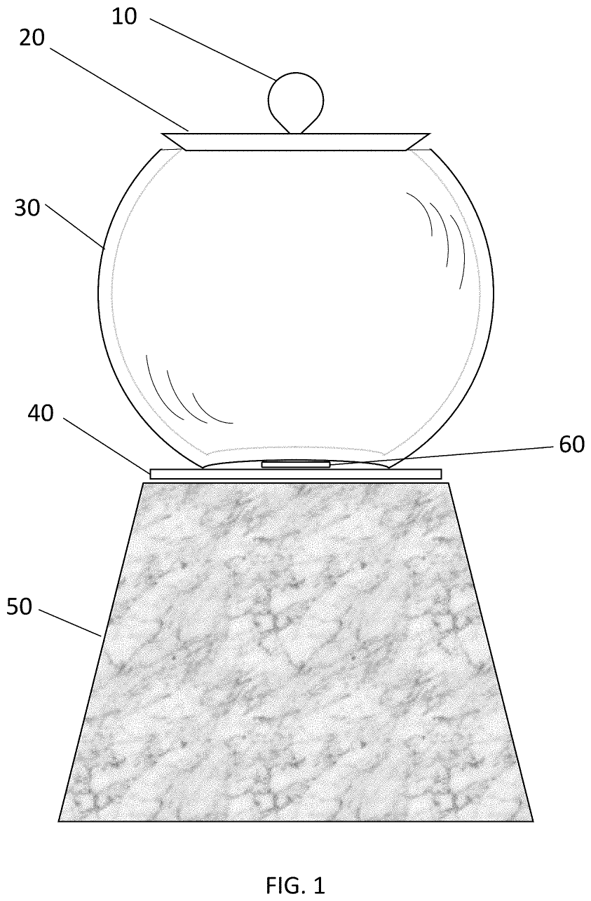

FIG. 2 shows an example of one of the preferred embodiments of my invention in sectional view and with Knob 10 and Lid 20 removed, in order to illustrate the means of connecting the Upper Container 30 and Lower Container 50 together as well as secure the Covering 70 to the Lower Container 50

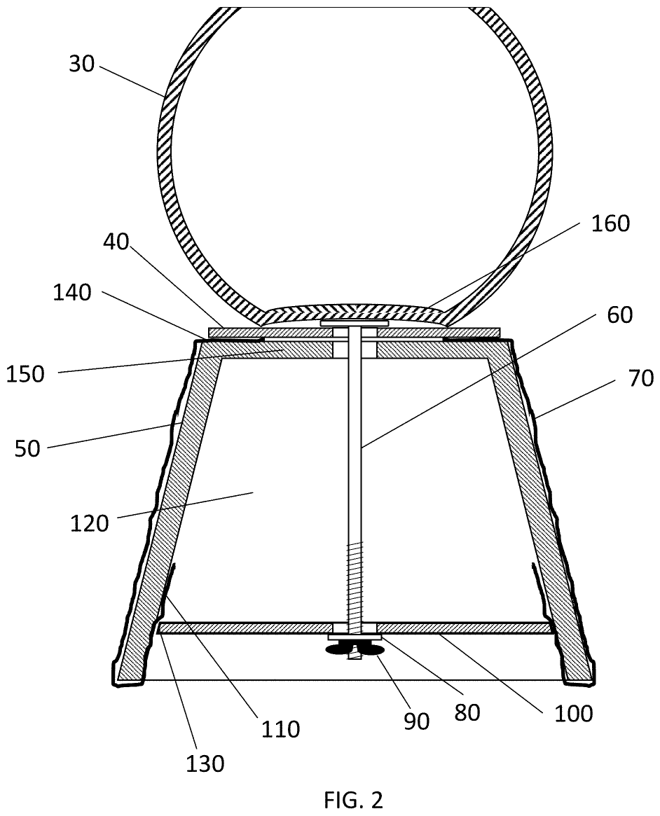

### LISTING OF REFERENCE CHARACTERS USED IN FIGURES

10—Knob
20—Lid
30—Upper Container
40—Base
50—Lower Container
60—Center Fastener
70—Covering
80—Washer
90—Fastener
100—Planar Surface
110—Lower Edge
120—Inner Volume
130—Outer Edge
140—Upper Edge
150—Top
160—Bottom Surface

### DETAILED DESCRIPTION OF THE INVENTION

One preferred embodiment of my invention includes an upper container, a lower container, a base beneath the upper container, a central fastener connected permanently to the bottom of the upper container and extending through the base under the upper container and through the planar surface perpendicular to it inside the lower container, a material covering fastened to the lower container, a washer and wing nut connected to the central fastener.

The material covering is securely fastened to the lower container by being captured at the top between the top of the lower container and the base, and at the bottom by being captured between the inner surface of the lower container and the planar surface, the tension being supplied by tightening of the wing nut onto the threaded central fastener. This tension is further used to securely connect the upper and lower containers.

Additional embodiments may include more than 2 containers and/or coverings on more than a single container.

I claim:

1. A device consisting of:
a center fastener 60
a base 40
a planar surface 100
a washer 80
a fastener 90
said center fastener 60 being permanently fastened to an upper container 30 and passing through a hole in base 40 as well as a hole in a lower container 50 and said planar surface 100 and said washer 80 and said fastener 90, and
a covering 70 fitting over said lower container 50, and
a lower edge 110 of said covering 70 being tucked into the inner volume 120 of said lower container 50, and
an upper edge 140 of said covering 70 folding in over the top 150 of said lower container 50, and
said fastener 90 being threaded onto said center fastener 60 thereby applying pressure on said planar surface 100 which moves said planar surface 100 closer to said upper container 30, and
said upper container 30 moving toward said base 40 resulting in said planar surface 100 pinching said covering 70 between said lower container 50 and the outer edge 130 of said planar surface 100, and also pinching the upper edge 140 of said covering 70 between said base 40 and said top 150 of said lower container 50. This results in said upper container 30 being removably attached to said lower container 50, and said covering 70 being held secure to said lower container 50 but still easily removed by disconnecting fastener 90 from fastener 60 and releasing the pinching force.

2. A device as described in claim 1 but not including base 40
said upper edge 140 of said covering 70 being pinched between the bottom surface 160 of said upper container 30 and said top 150 of said lower container 50

3. A device as described in claim 1, with
said center fastener 60 being removably fastened to Upper Container 30
